(19) United States
(12) Patent Application Publication
(10) Pub. No.: US 2004/0015372 A1
(43) Pub. Date: Jan. 22, 2004

(54) Method and system for processing and aggregating medical information for comparative and statistical analysis

(76) Inventors: Harris Bergman, Smyrna, GA (US); David Ku, Atlanta, GA (US); Brian Neimeyer, Alpharetta, GA (US)

Correspondence Address: BERNSTEIN & ASSOCIATES, P.C., Suite 495, Embassy Row 400, 6600 Peachtree Dunwoody Road, N.E., Atlanta, GA, 30328-1649, US

(21) Appl. No.: 10/039,295

(22) Filed: Oct. 19, 2001

Related U.S. Application Data
(60) Provisional application No. 60/242,028, filed on Oct. 20, 2000.

(51) Int. Cl. G06F 17/60

(52) U.S. Cl. 705/3

(57) ABSTRACT

A method and system for processing and aggregating medical information for analysis, including distributing the initial data acquisition among multiple medical practices, transferring data over the Internet, storing data in a centralized database, and providing Internet-based applications and services using the data—aggregated or individually—to be used in the care or management of patients. Examples of such applications include, but are not limited to, using the database to train and re-educate computer-assisted diagnosis and detection software and using the database like a textbook to compare abnormalities observed in an present patient to those of other patients with confirmed diagnoses. The method and system provides improvements in the practice of medicine because it delivers real-time decision support to physicians and uses the most current information available in so doing. By analyzing a current patient's medical information and comparing it against similar data in a central database, the physician can receive an objective computerized “second opinion,” and every new patient gives the database an additional medical file by which the database can grow in breadth.

### CROSS REFERENCE TO RELATED APPLICATION

This application claims benefit of copending U.S. provisional application No. 60/242,028, filed Oct. 20, 2000, entitled “Method and system for processing and aggregating medical information for comparative and statistical analysis”, the disclosure of which is incorporated in its entirety herein by reference.

### FIELD OF THE INVENTION

The present invention relates to a method and system for processing and aggregating medical information for analysis, including distributing the initial data acquisition among multiple medical practices, transferring data over the internet, storing data in a centralized database, and providing internet-based applications and services using the data—aggregated or individually—to be used in the care or management of patients.

### BACKGROUND OF THE INVENTION

Few medical tests are 100% accurate. Even with the best data made available to the physician, medical errors still occur. Recently, several decision support tools—often embodied as software—have been developed to address the problem of misdiagnosis. For example, a pharmacist's label-printing software may connect to software that checks for drug interactions. These systems have several limitations that have hindered their adoption and reduced their benefit to the general public. Two major limitations are that they are often based on small clinical studies and that their use adds significant work and/or time for the physician.

Computer-aided detection and/or diagnosis (“CAD”) is a class of systems that analyze medical data to help a physician determine a diagnosis. In the field of radiology, CAD systems have been developed to look for abnormalities in chest x-rays, heart scans, mammograms, and the like. They work by performing image processing on digitized radiological examinations (both native digital and digitally-scanned film), identifying potential abnormalities and measuring their visual properties, and then determining whether these properties are indicative of a positive finding. The determination process may involve the use of empirical equations, rules (i.e., an “expert system”), or artificial intelligence; in any case, the specific parameters and weights used in this process are based on the results of clinical studies of patients. As with most scientific models, the accuracy of the CAD system is related to the sample size of the group (in this case number of patients) on which it was developed.

The only known presently commercially-available CAD system for the detection of breast cancer suffers from both the limitation of having been developed on a small sample of patients and also adding significant time that the physician must spend to interpret the mammogram and use the system. This system is a stand-alone computer-device mounted to a film reading station. Film is inserted into the device and, several minutes later, an analysis is presented. While it is processing the physician must wait. The decrease in physician productivity hinders the acceptance and use of these systems.

The present invention solves these and other limitations. The method and system described herein provides the infrastructure by which effective data-driven applications such as medical decision support or epidemiology research can be performed with high accuracy, ease-of-use, and portability.

Other objects, features, and advantages of the present invention will become apparent upon reading the following detailed description of embodiments of the invention, when taken in conjunction with the appended claims.

### BRIEF DESCRIPTION OF THE DRAWINGS

The invention is illustrated in the drawings in which like reference characters designate the same or similar parts throughout the several figures of which:

FIG. 1 is a object model view of the system architecture of a preferred embodiment of the present invention.

FIG. 2 is a schematic view of the integrator.

FIG. 3 is a schematic view of the CAD preprocessor. FIG. 4 is a schematic view of the exam flow overview.

FIG. 5 is a schematic view of the physician website map.

FIG. 6 is a schematic pictorial view of the system.

FIGS. 7A and 7B are screen shots of an overview of the system.

FIGS. 8A-8W are additional presentation views of aspects of the invention.

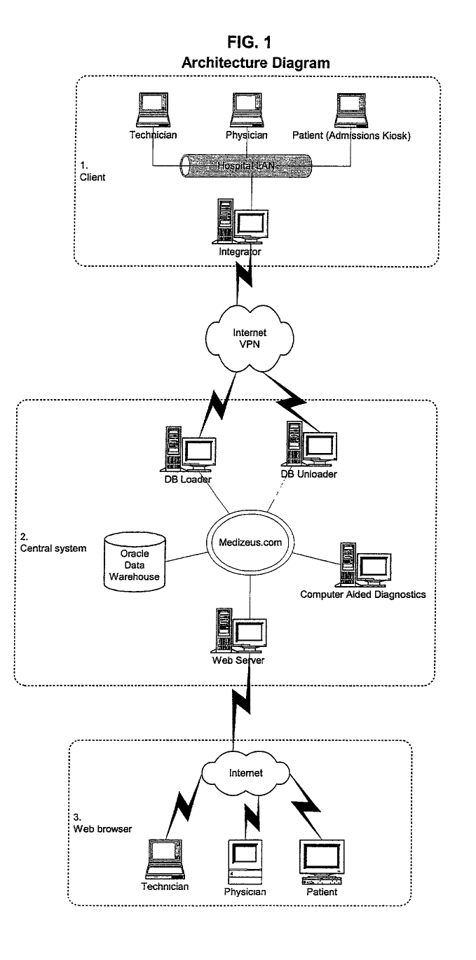

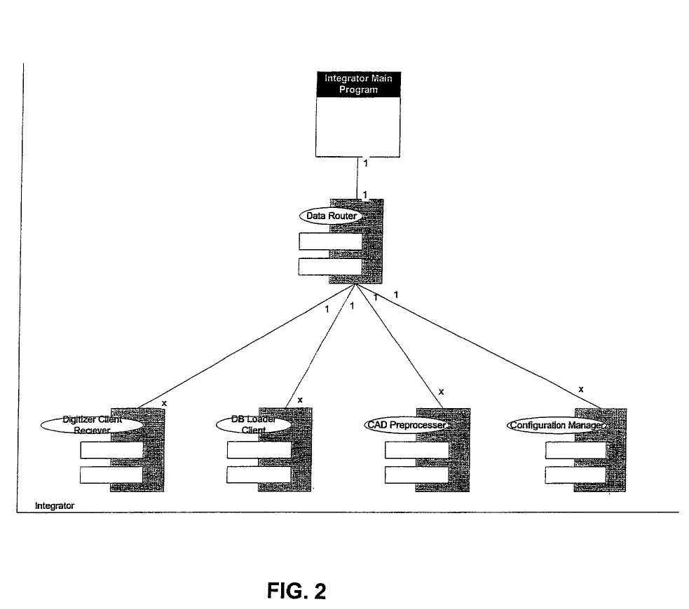

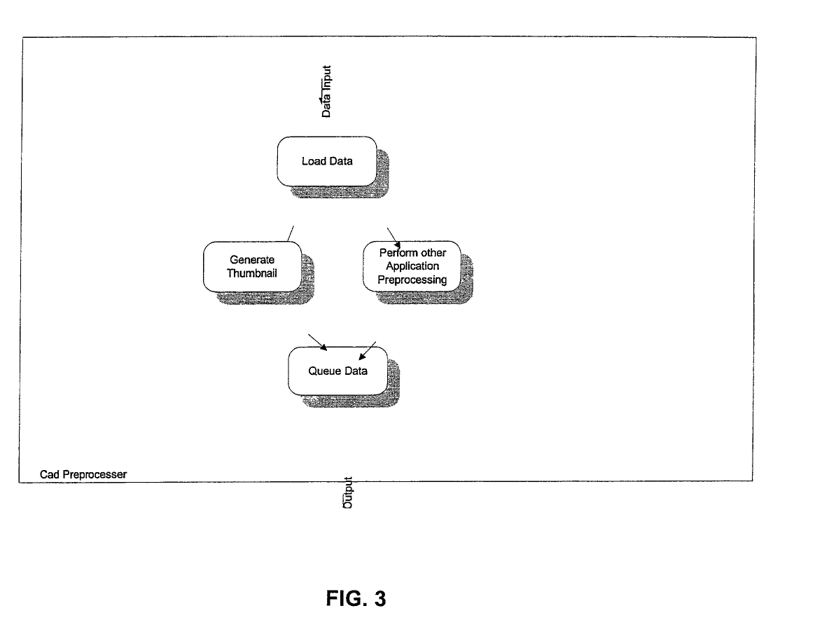

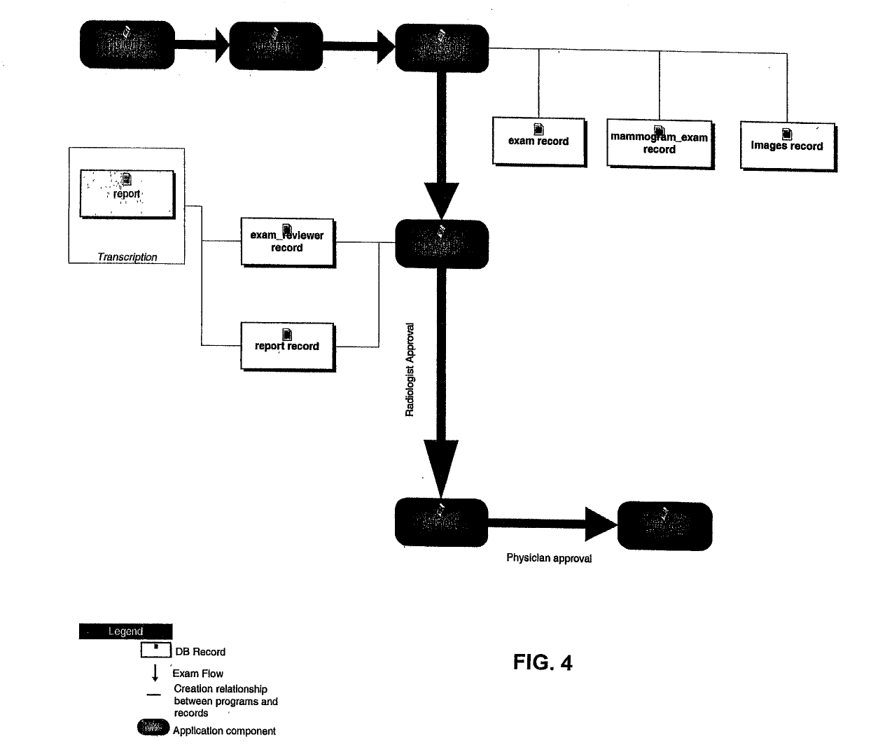

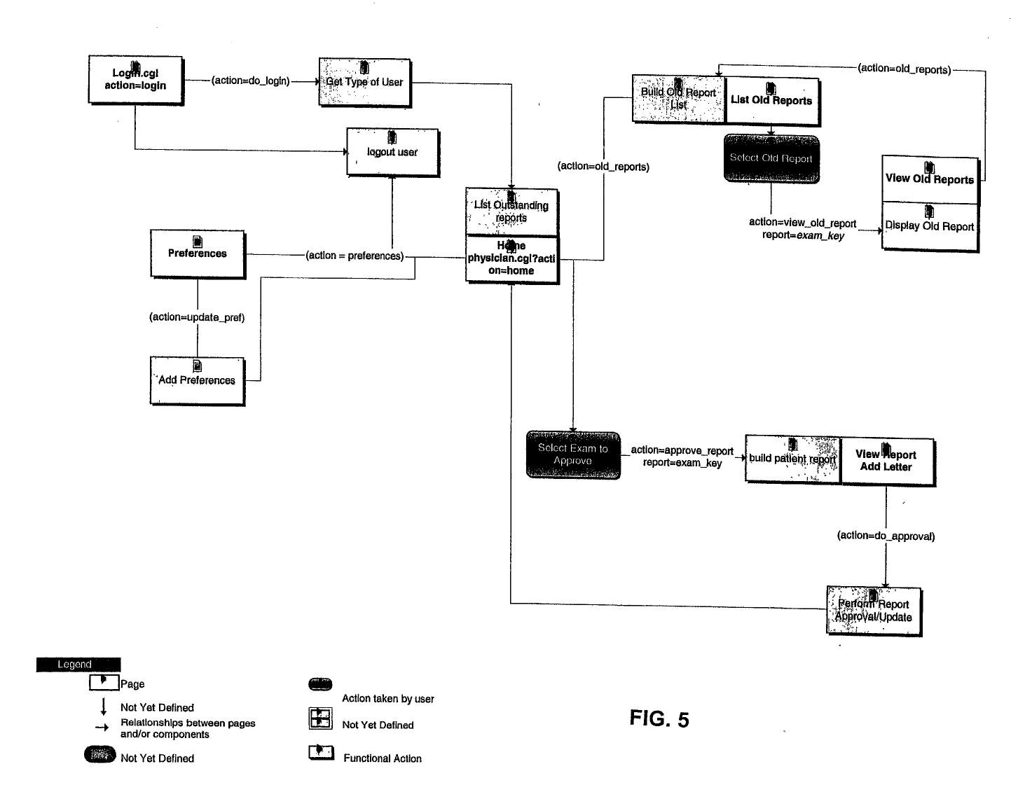

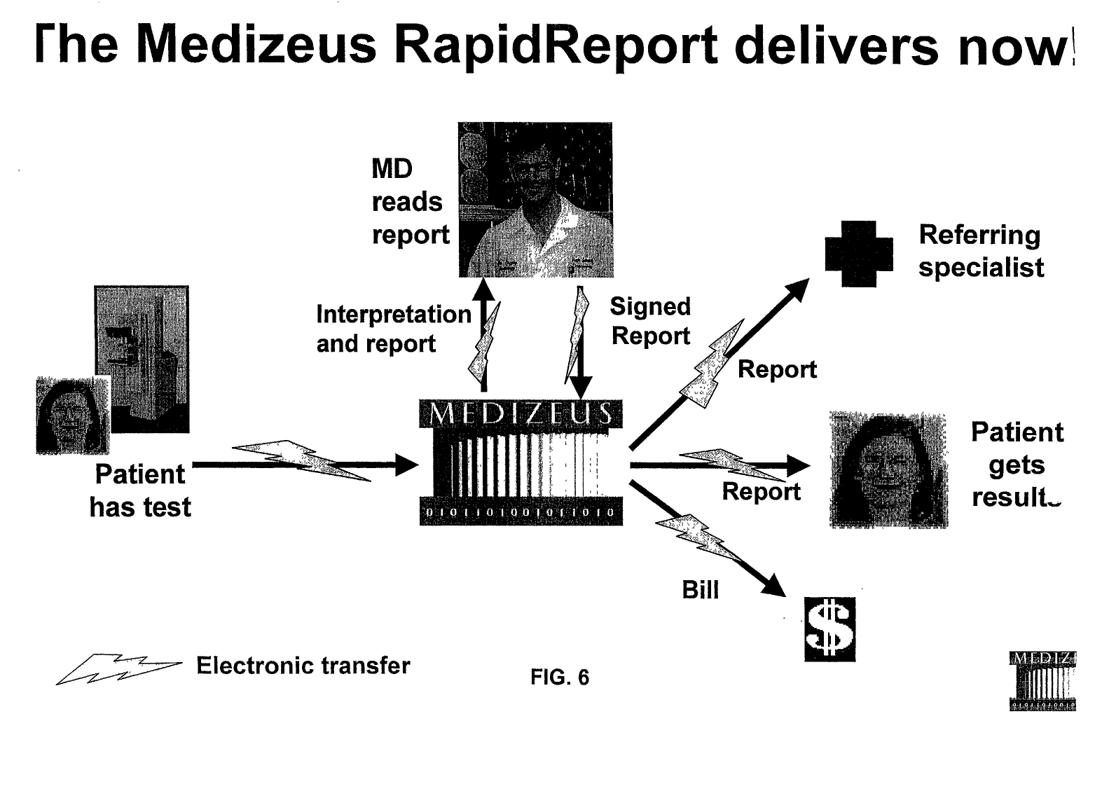

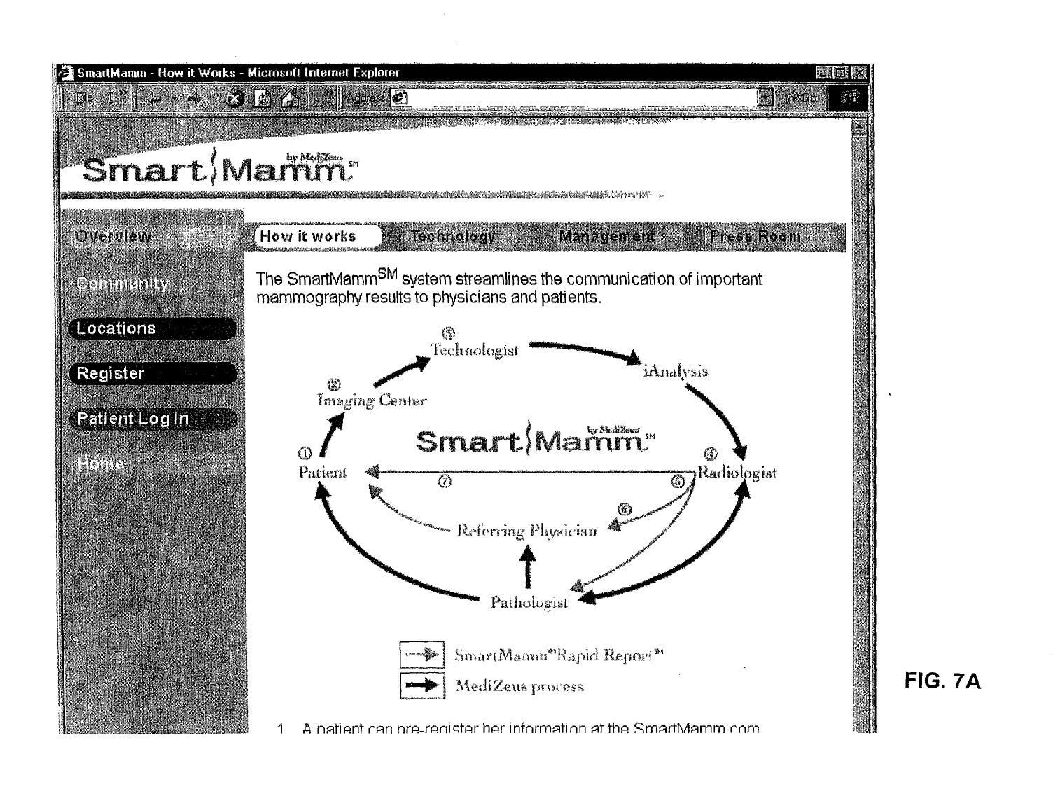

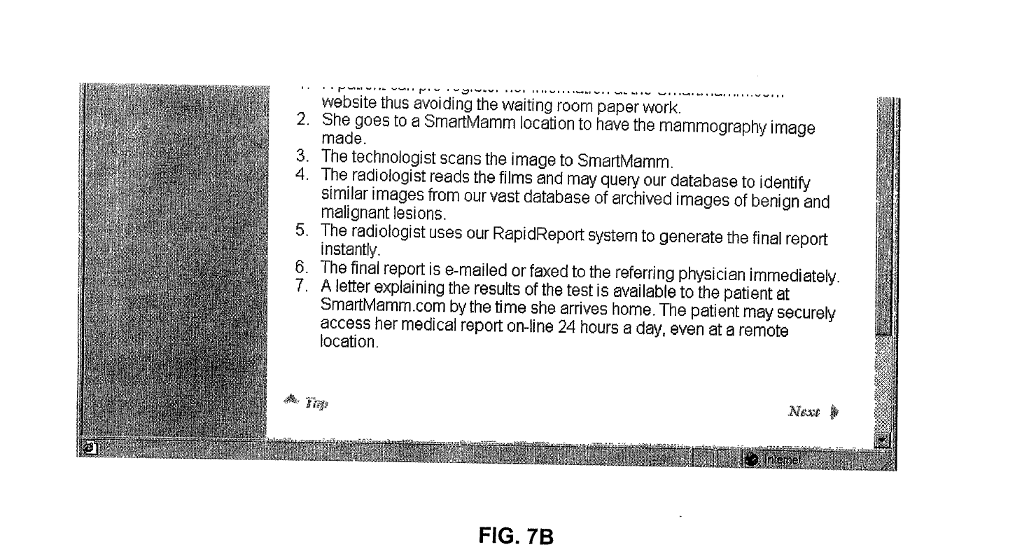

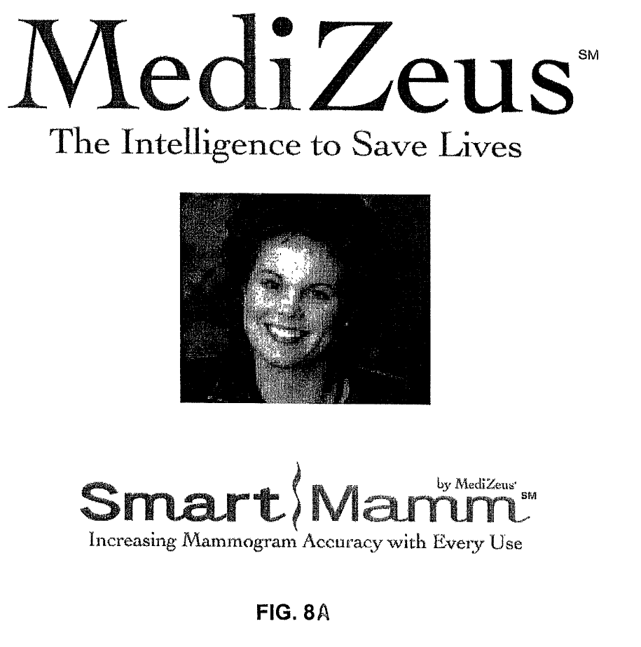

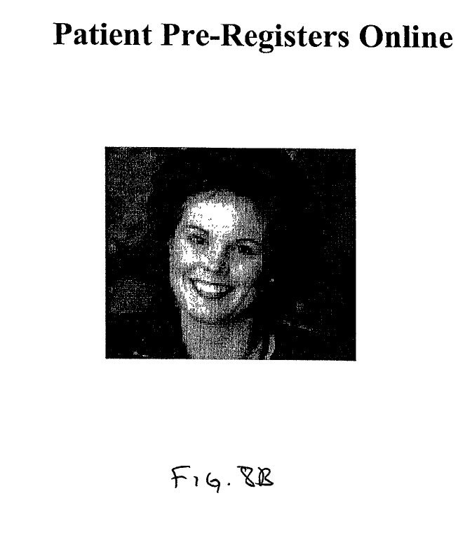

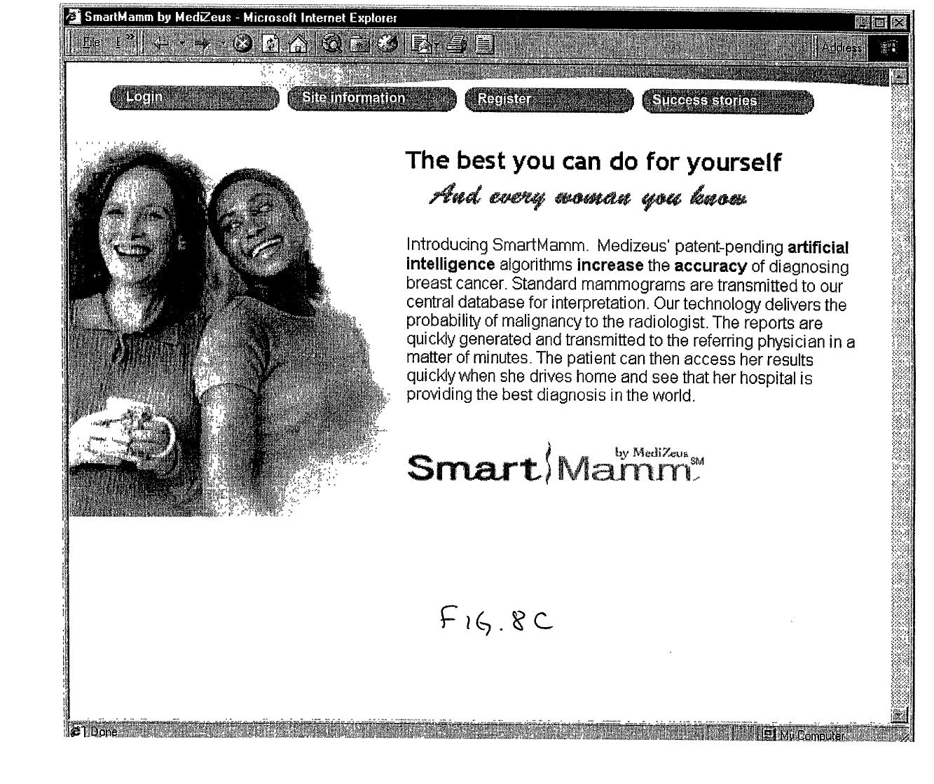

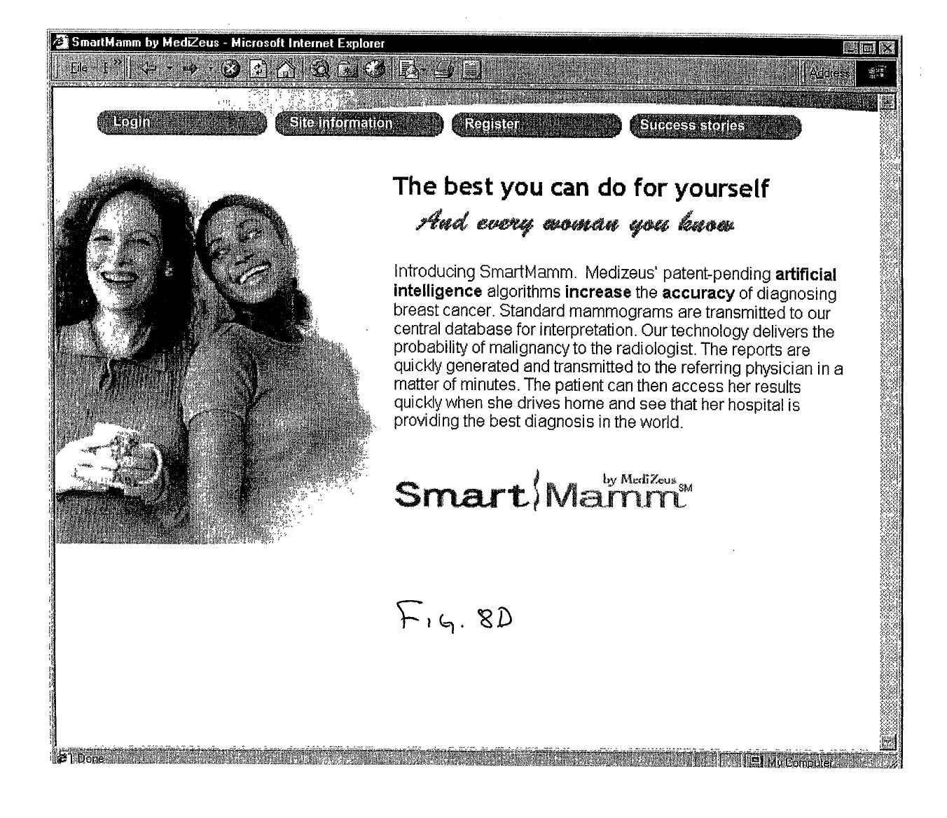

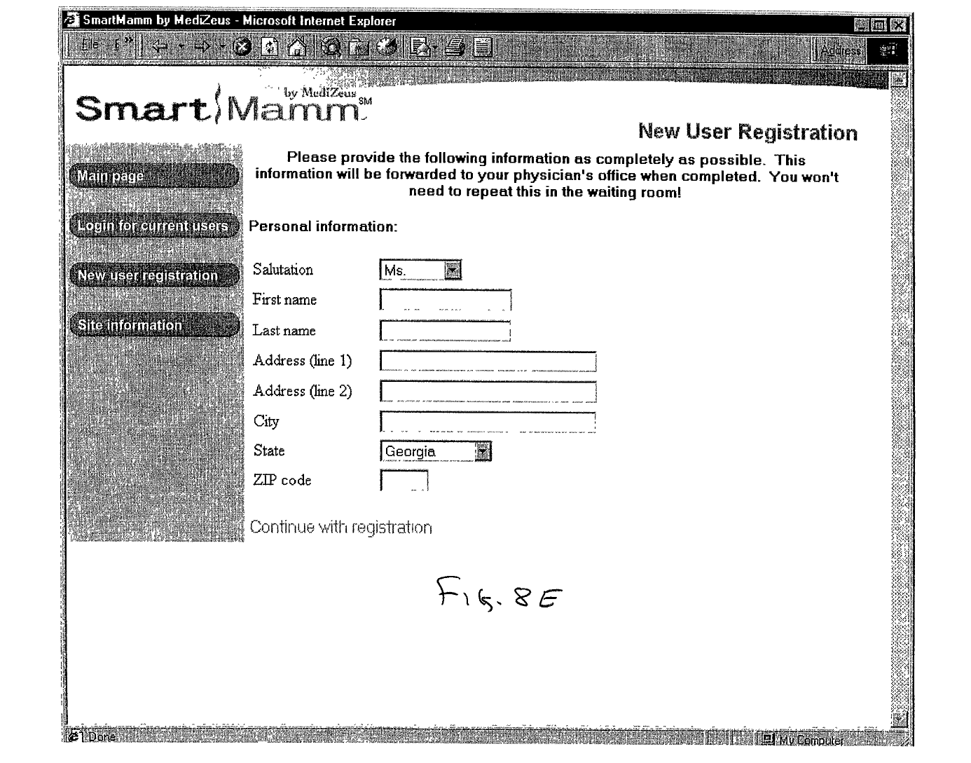

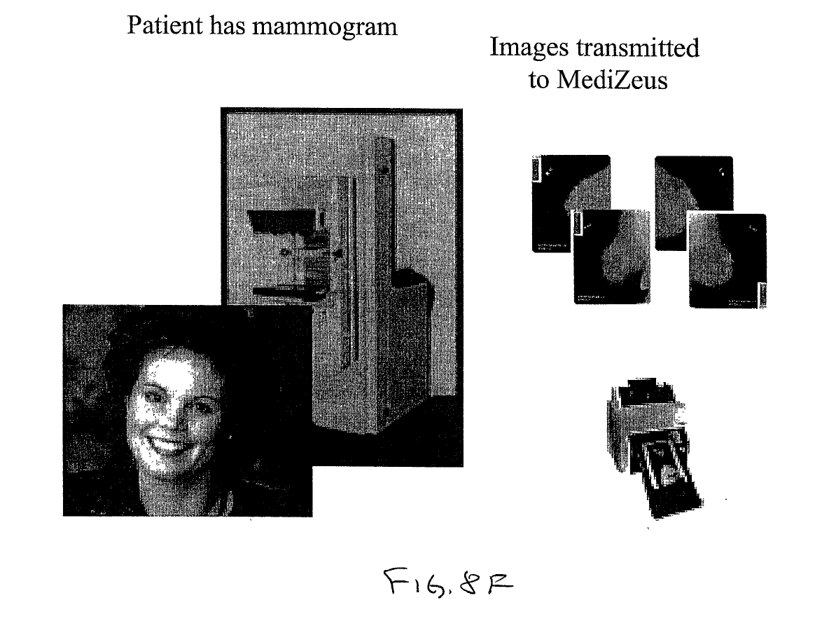

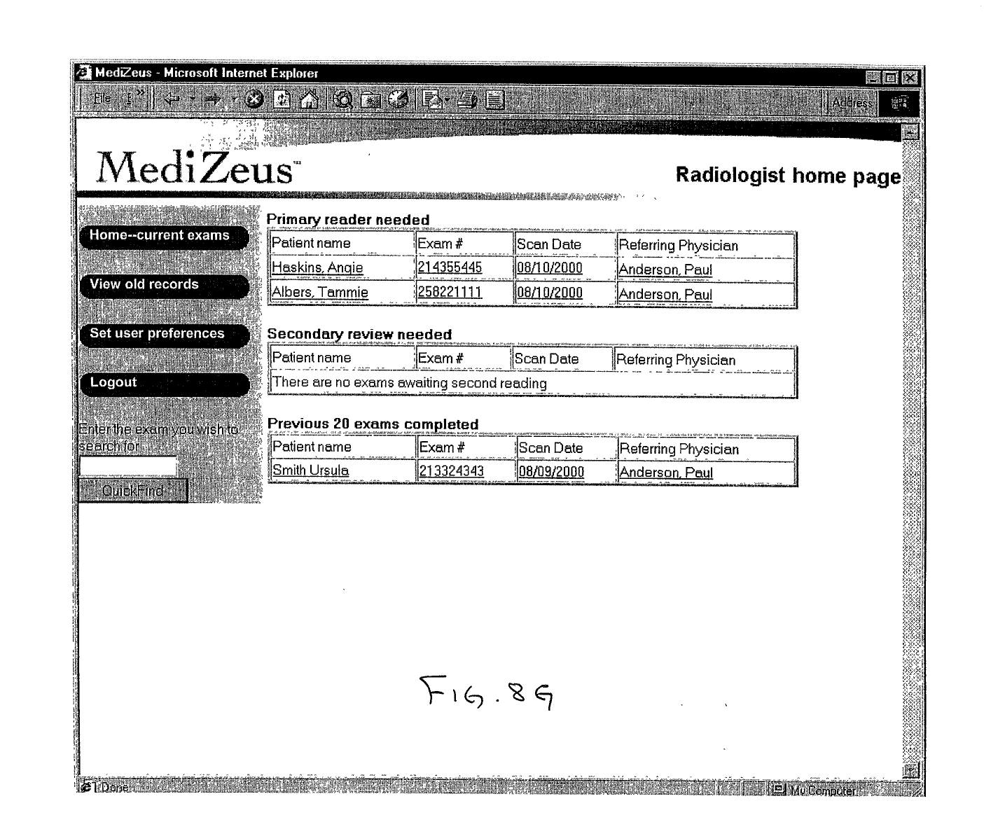

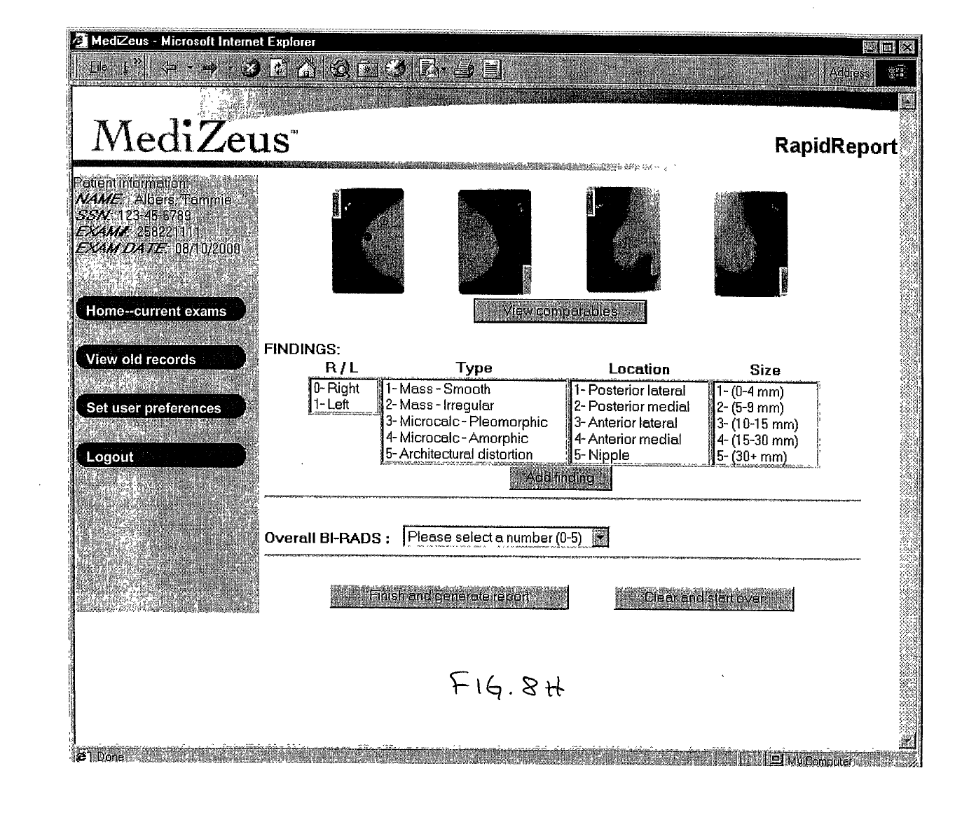

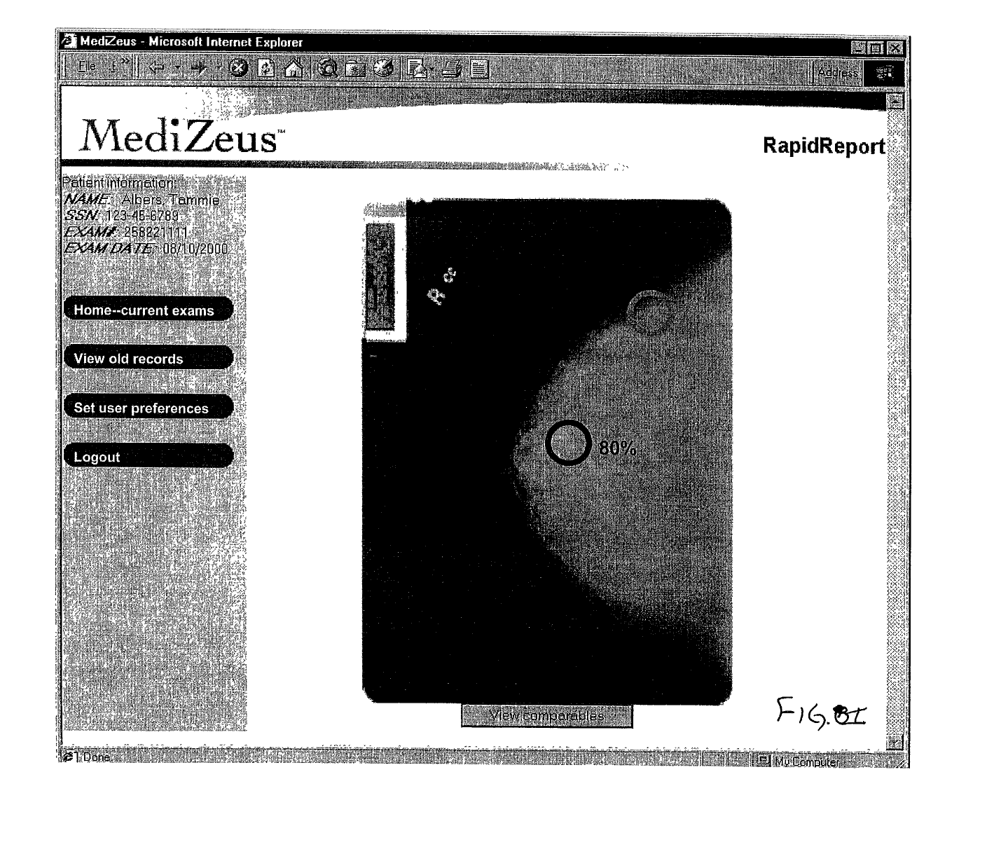

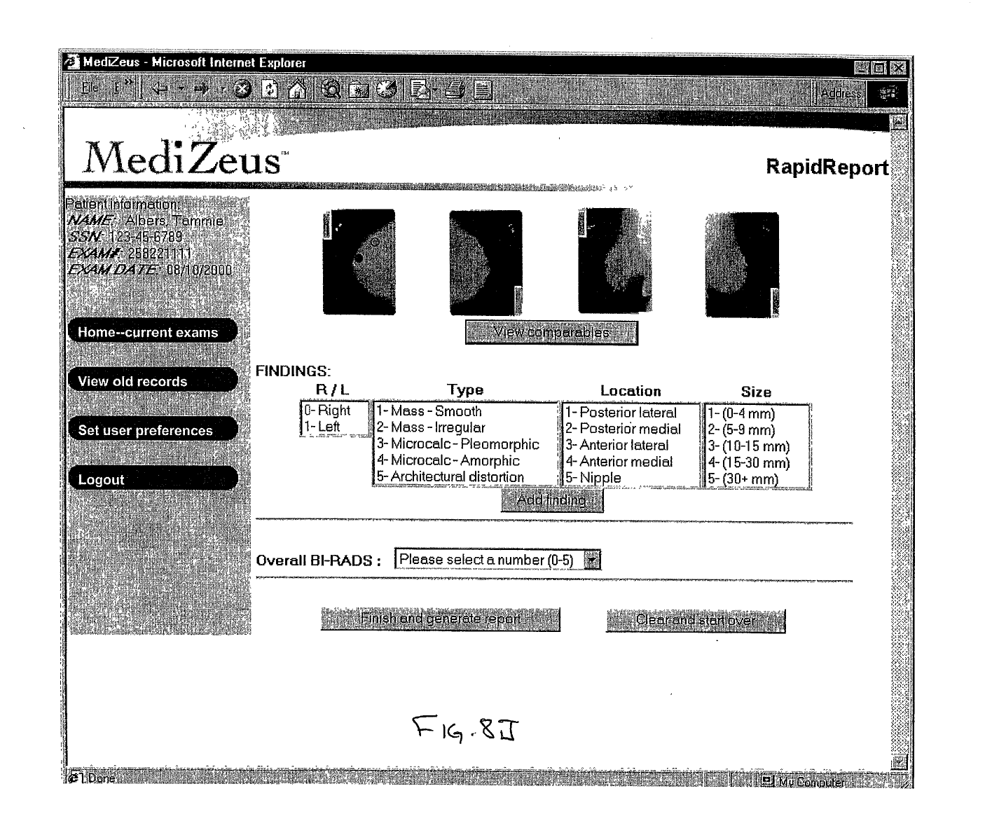

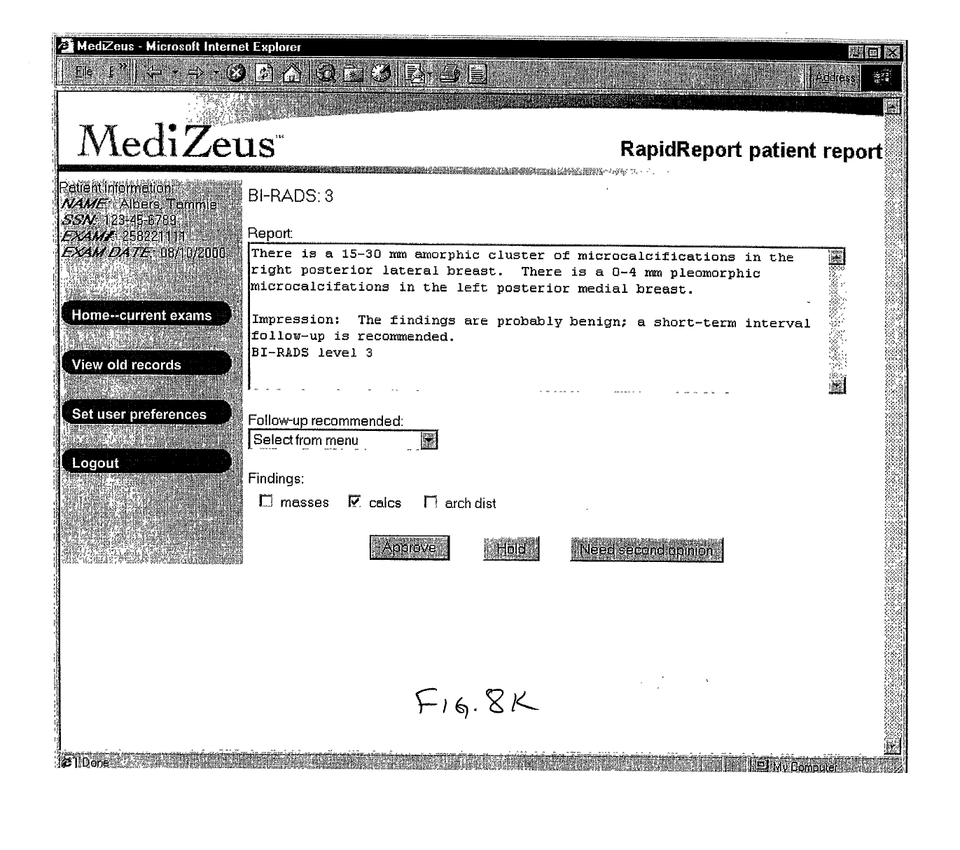

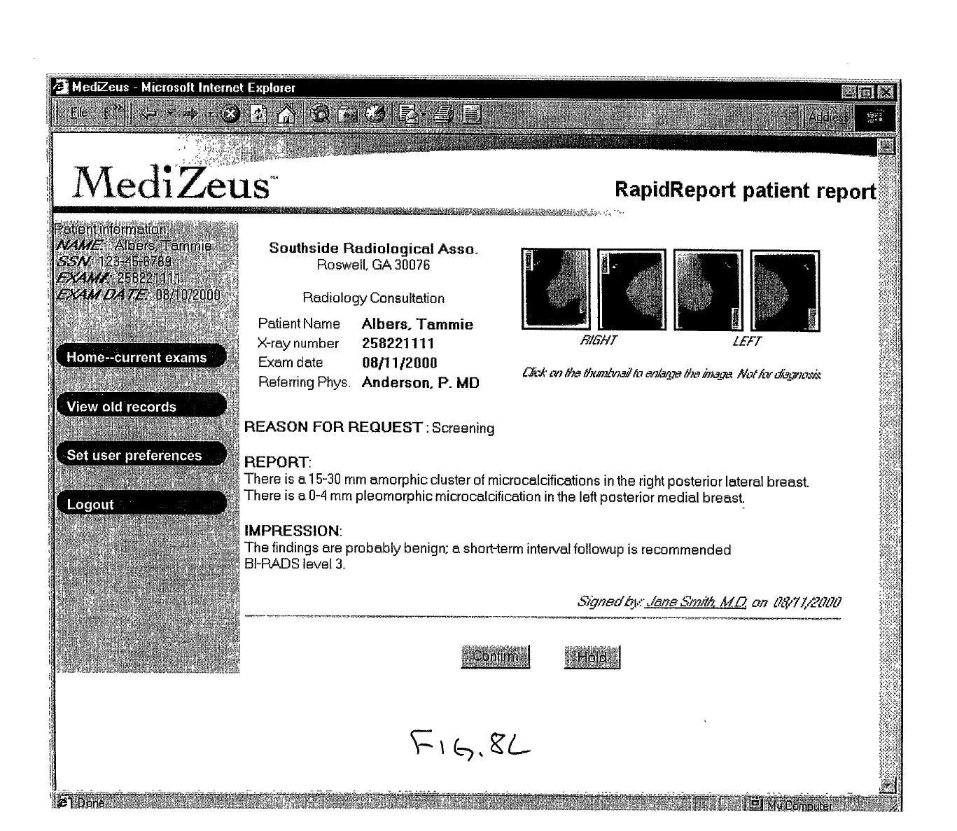

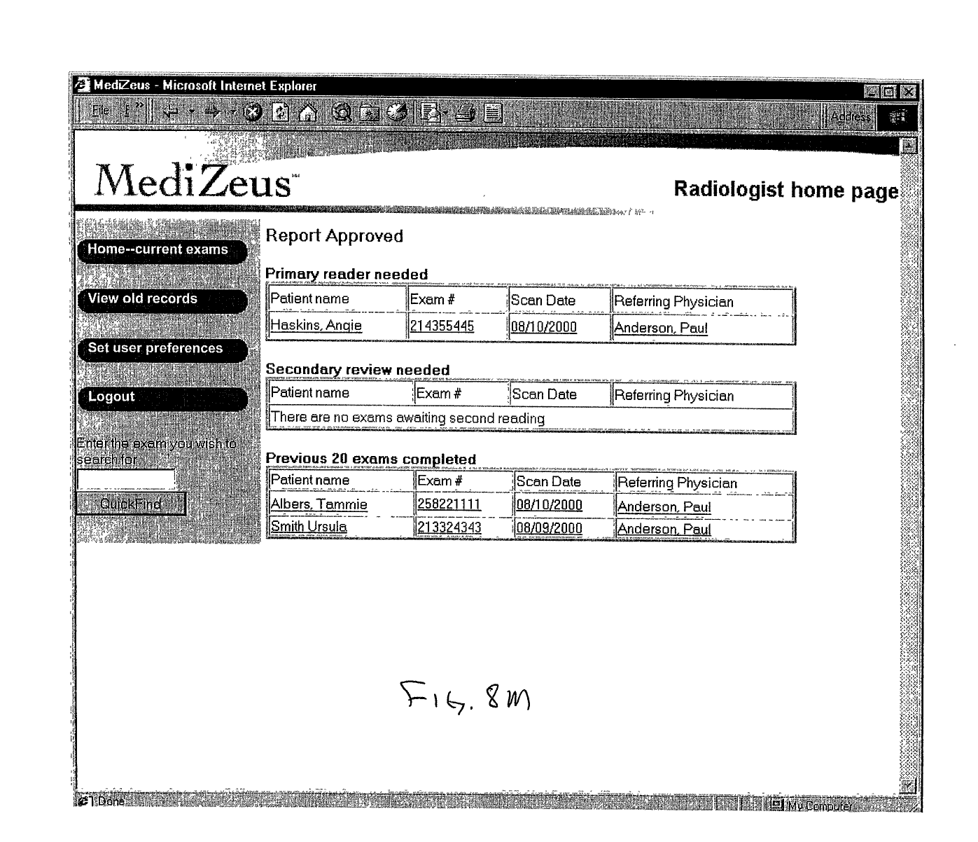

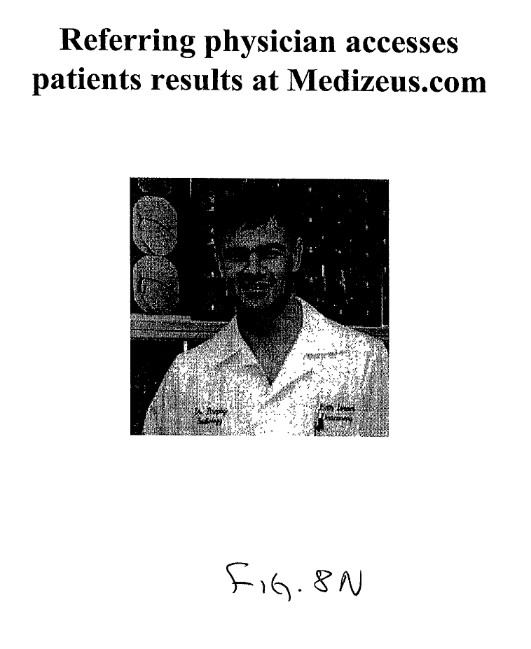

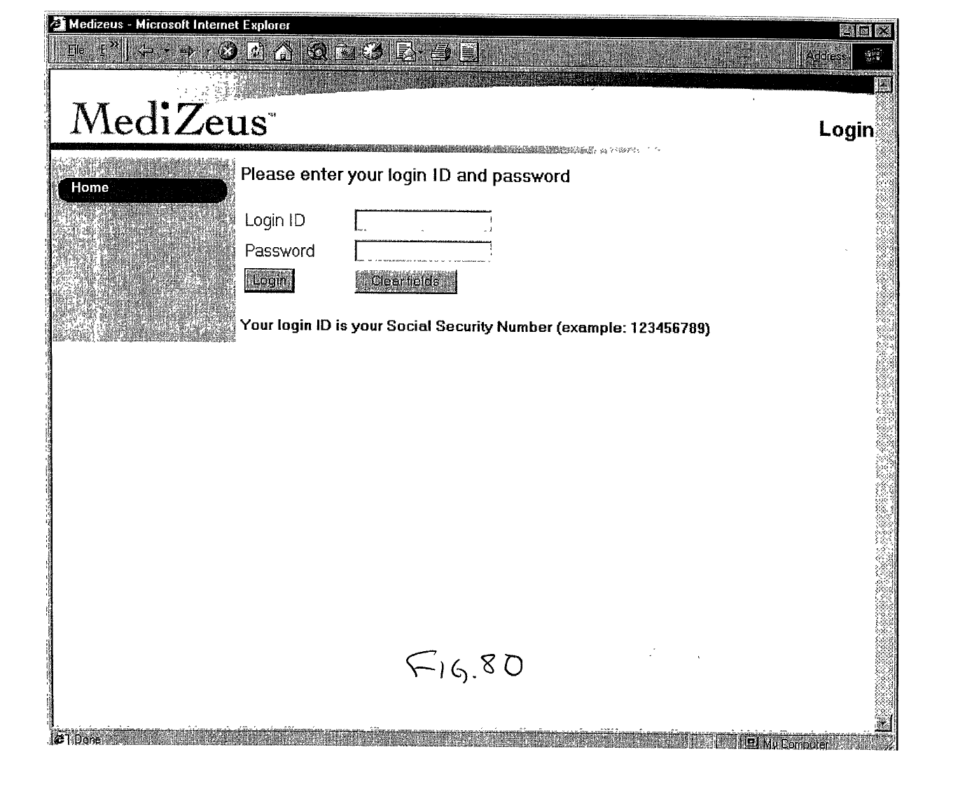

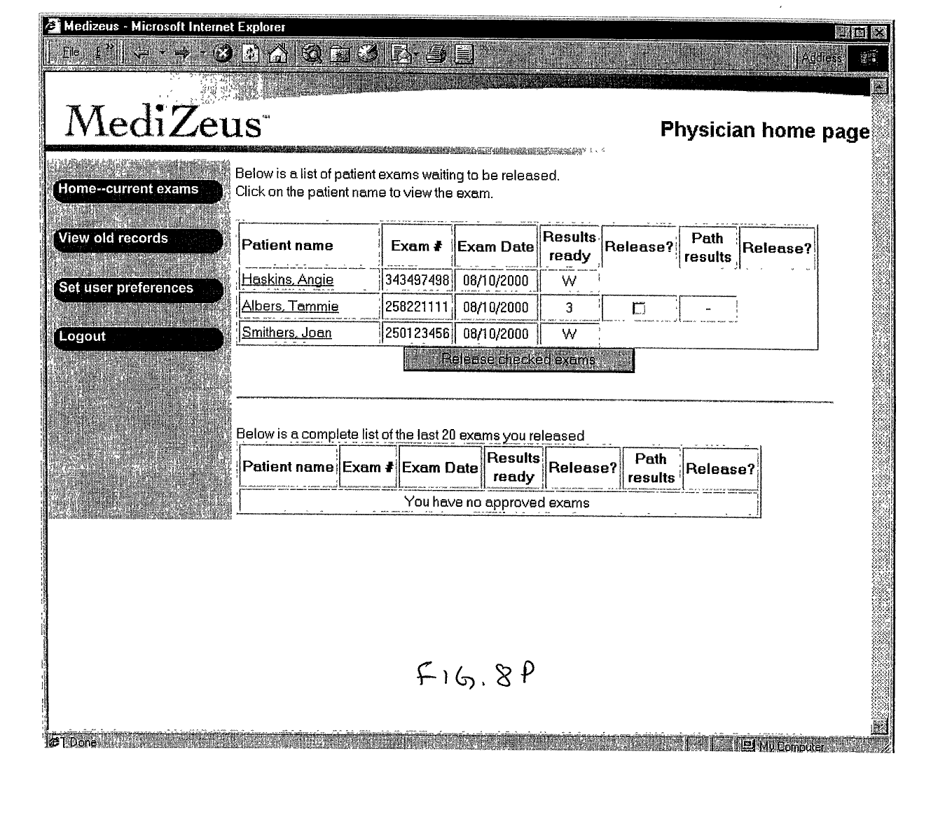

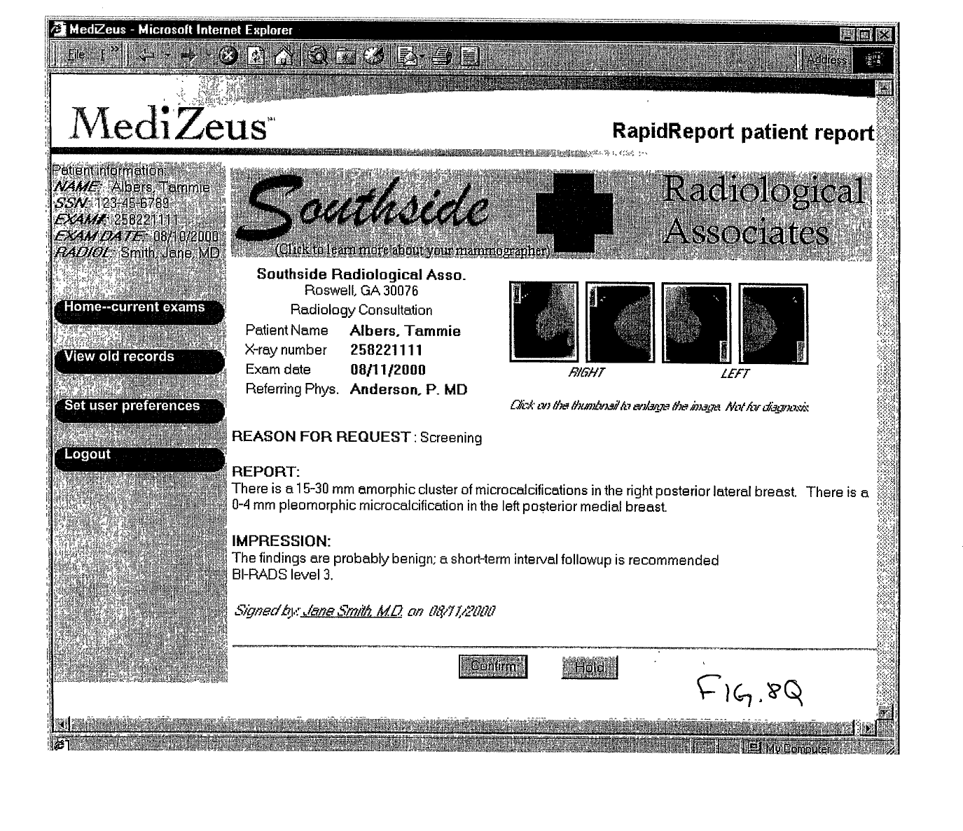

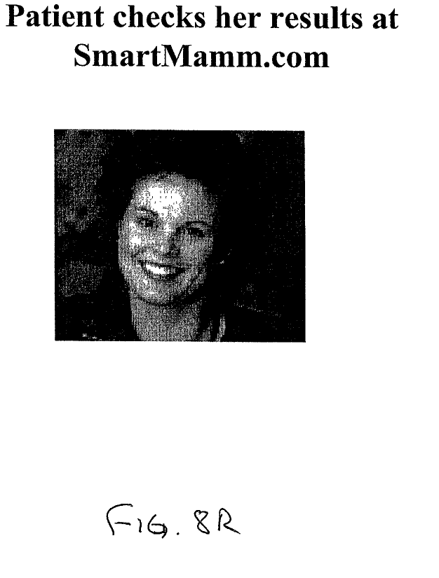

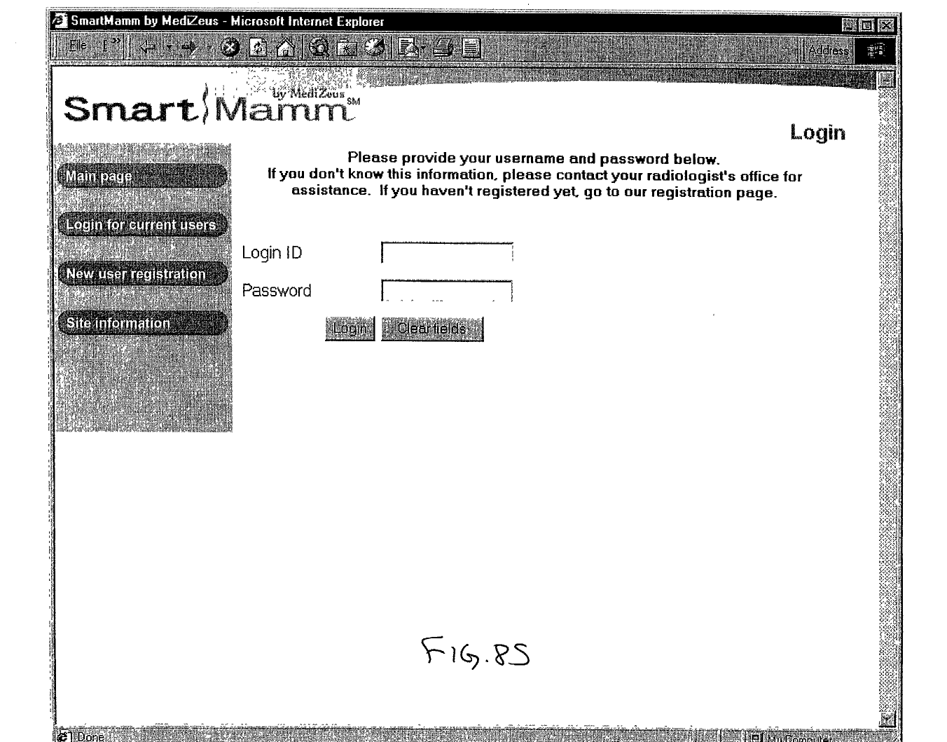

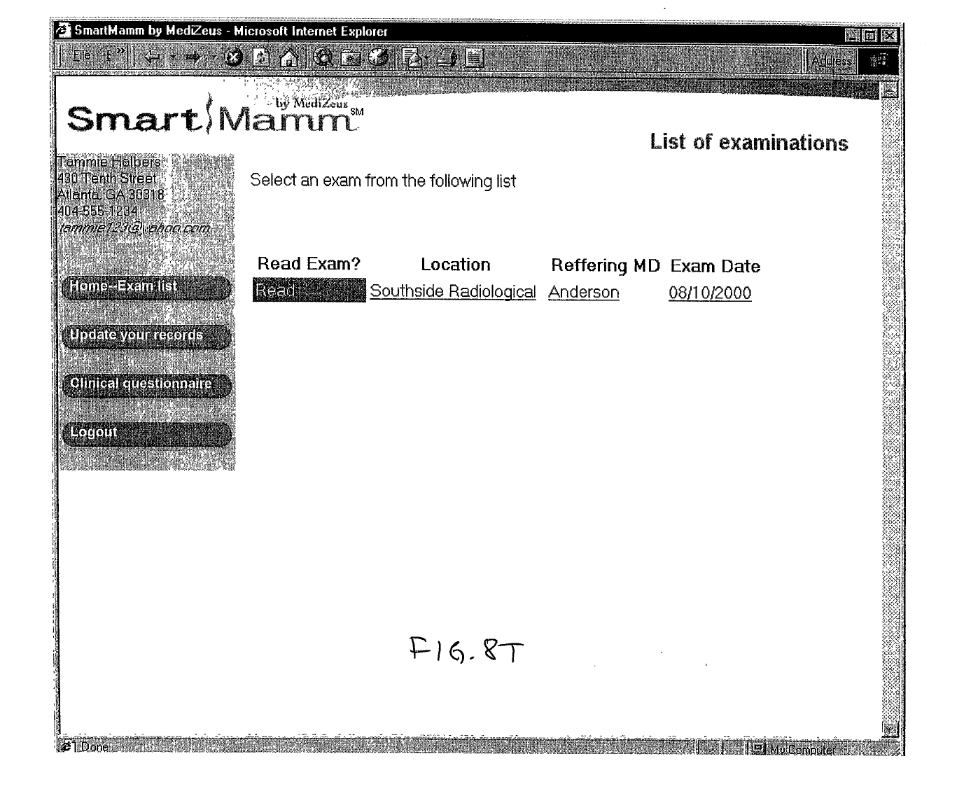

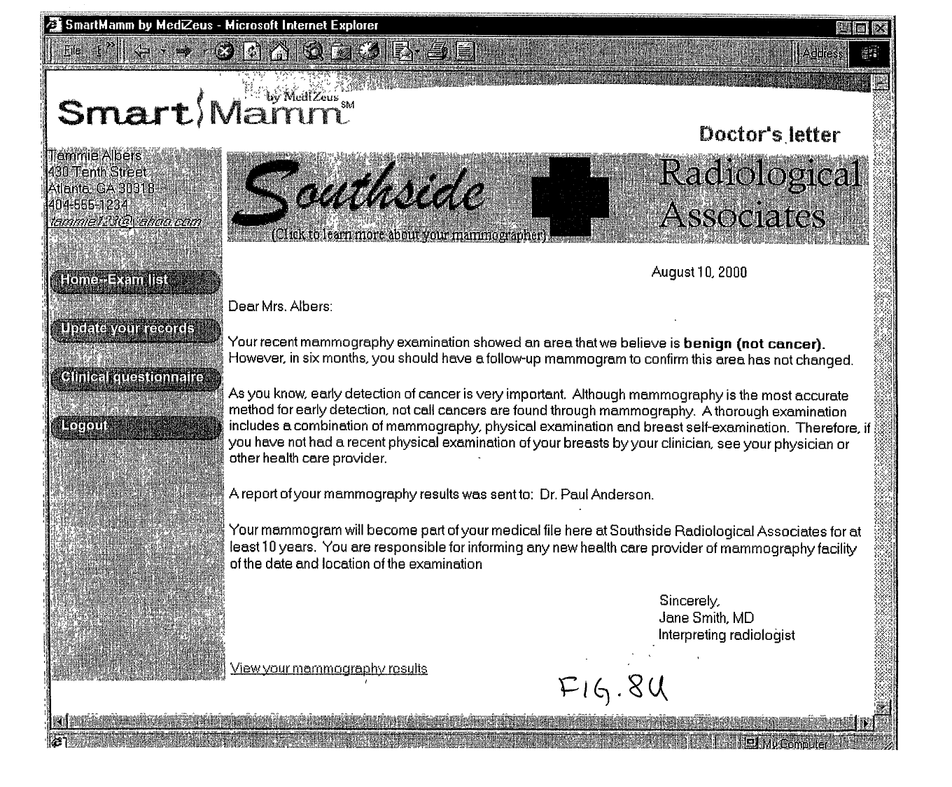

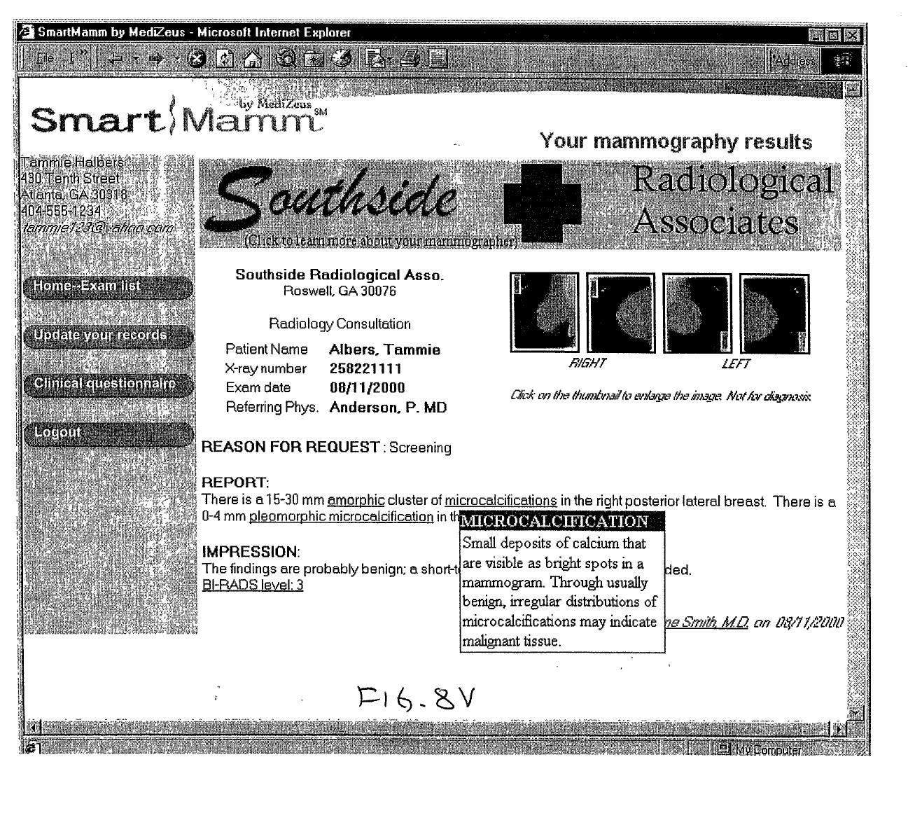

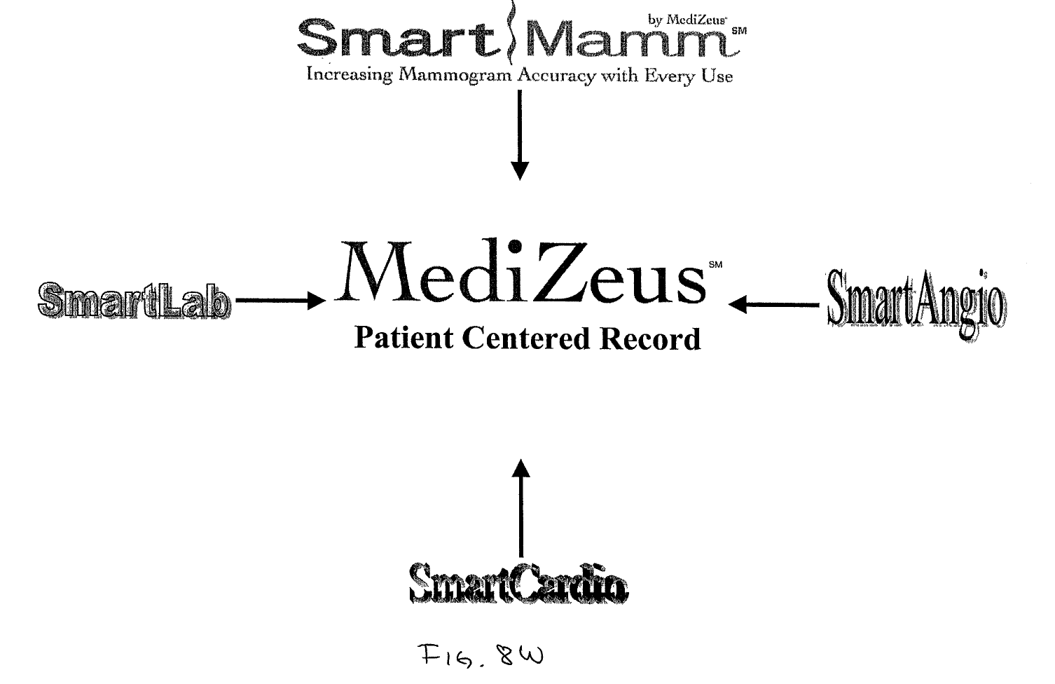

### DESCRIPTION OF THE PREFERRED EMBODIMENT

The motivation for inventing this method and system is to make a product that encourages physicians to send patient information to the central database. As the database grows, many valuable applications that require aggregated medical information can be deployed, such as CAD.

In a preferred embodiment of the present invention the system comprises three parts: 1) a client module (“client”) in a doctor's office, 2) the central system of a database and connected servers, loaders, and unloaders, and 3) at least one web-browser running at least one application.

The client in the doctor's office initially obtains the medical information. Depending on the type of information to be transmitted, the client could take several forms, such as, but not limited to, a web-browser, medical device, film digitizer or other form known to those skilled in the art or developed hereafter. Regardless of its form, the client will perform certain tasks: acquire medical information in digital form, perform some processing of the medical data, be attached to the Internet, periodically initiate a secure and/or encrypted connection between itself to the central database/server/loader over the Internet, and transmit the medical information across the connection.

The central system consists of the database and connected servers, data loaders, and data unloaders. The central system may be behind a firewall, Virtual Private Network or other device. Servers form connections to the clients mentioned above. At least one data loader takes the medical information deposited on the server and loads the data onto the appropriate tables in the database. At least one application server can query the database to perform analyses of the medical information on individual or aggregate (personal identifiers redacted) basis, for part of an Internet-based application. Analyzed data can also be stored on the database. The data unloaders and servers act as the intermediary between the database and the application.

Web-browsers can access applications that utilize the analyzed data from the database. Confidentiality of patients' data can be maintained by using encryption or similar technology over secure network. Applications can be developed for physicians, patients, or third parties. Potential applications range from patient registration in a doctor's office to the real-time comparison of a patient's chest x-ray to those of thousands of other patients.

CAD is one application that is well suited for the system of the present invention. In this case, patient information includes test data such as radiological images, a radiological report (i.e., the interpretation), and possibly additional, confirming reports (e.g., a pathology report, surgical notes, and the like). The CAD application would compare and analyze a new patient's test data against the aggregated data to suggest an interpretation. From a web browser, a physician can access the CAD results and make a more accurate diagnosis. Because the development and updating of CAD applications require both raw test data and confirmed diagnoses, the system can also extend an application to permit physicians to add confirmed results to a patient's record when the results become available. Each patient added to the database, whose record contains both raw test data and the corresponding confirmed results, can then be used to update the CAD application.

The key to the system is to “close the results loop,” that is, to obtain not only patient test data but also the confirmed results. Critical to the commercial success of such a system is the development of a broad variety of tools, harnessing the system, to improve the productivity and quality of a physician. Web-based applications such as report composition and patient registration provide incentives to add their patient information to the central database. Additionally, applications that increase the productivity of nurses and technicians can also be incorporated. An advantage of such applications is to encourage the entire staff of a medical practice to keep data stored in the central system. In doing so, additional information can be gathered into the database. An example of this kind of application is an online patient registration service, whereby patients type in their medical histories (for example), so that a nurse does not have to do so later.

The first application is directed to the detection of breast cancer in mammograms. The application streamlines the generation of the mammography report, and organizes and transports the medical images and reports in an efficient manner over the Internet to referring doctors, patients, and care providers. In a preferred embodiment, the application and underlying system utilize the newly available Internet as a Wide-Area-Network with high bandwidth, which was not part of healthcare information technology (HIT) solutions just a few years ago. All reports and images are available anytime, anywhere. A radiology practice also has the opportunity to get inside their patients' homes through “active letterhead” co-branding; patients can easily learn about their mammographer and other services the practice provides.

Behind the scenes, the system's application server compiles and archives patient data. With its permanent archive, the system can serve as a fulfillment center for distributing patient information. The database may be mined for reports on which patient sector best benefits from more frequent scans. Likewise, the cost-benefit analysis can be made for less frequent scanning of younger women. For example, data from the archive can be sold to insurance companies to study outcomes and quality control. The mammography CAD interpretation system can become more accurate as the patient archive grows in size and the CAD is updated on an increasingly more robust patient population.

In cases where the image data is small and can be transmitted quickly to the central server, it may not be necessary to have parts (1) and (2) on the Integrator; instead, all the parts can be performed at the Central system.

Page 5 makes it seem like the images are sent to the central system and all analysis occurs there. In fact, the Integrator (residing at the hospital) does the initial processing before sending the images to the central system.

This is necessary for mammograms because the images are very large (over 100 MB per patient!); for other types of exams, this is not so necessary.

Computer-Aided Diagnosis (CAD) was invented to help radiologists make more accurate diagnoses. These systems can make an objective “second opinion,” with which the radiologist can use. CAD algorithms in the field of radiology typically have three parts:

1) Feature extraction, where abnormalities of interest are isolated from the rest of the image. Extraction involves image processing techniques.

2) Feature analysis, where visual properties (such as size, darkness, border shape, etc.) of the extracted abnormality are measured.

3) Computation of the result. A “diagnosis” is calculated from the properties measured in (2). The relationship between the properties and the diagnosis is often very complex. Expert systems (e.g., “rules”) and artificial intelligence (e.g., “neural networks” or “Bayesian networks”) have been used to determine the relationships. Typically, the relationships are empirically determined and can be made more accurate when there is a large amount of validated data (feature properties and a corresponding confirmed diagnosis) from which to determine the relationships.

The results from (3) can be presented to physicians in many fashions, from a paper note indicating the result to an annotated digital image.

The present invention provides a system for performing CAD. In the invention, parts (1) and (2) are performed on the Integrator, and part (3) is performed at the central system. The reason for doing so is that it takes a good deal of time to transmit the images from the hospital to the central system. By performing the extraction and analysis steps at the hospital, the diagnosis can be received at the central system in a most expedient manner.

For purposes of displaying the results to the physician in a friendly manner, the Integrator also generates small (less than 100 KB) versions of the large images and transmits them with the feature analysis data. Thus, the computed result, or diagnosis, can be visually displayed with the small version of the image; using a Web server at the central system, physicians can get access to the results from a Web browser.

The above describes a CAD system for radiological images. Other types of medical analysis can also be performed with the present invention. Other web applications tied into a CAD service can gather patient information such as current medications and family history. The broad medical data can also be analyzed in a manner similar to step (3) above, for determining things like drug interactions and risk factors for diseases.

In summary, the value of this system is in having an infrastructure by which physicians send and store medical information on a central database, so that the database grows at a fast rate and can support applications that analyze aggregated medical information. Furthermore, the present invention can protect intellectual property and confidentiality of CAD software and results, and perform CAD using a real-time database in an expeditious manner.

Further aspects of the invention and a systems architecture overview are shown in the following section having the heading “Systems Architecture Overview.”

[image]

[image]

[image]

[image]

[image]

[image]

[image]

[image]

[image]

Although only a few exemplary embodiments of the invention have been described in detail above, those skilled in the art will readily appreciate that many modifications are possible in the exemplary embodiments without materially departing from the novel teachings and advantages of the invention. Accordingly, all such modifications are intended to included within the scope of this invention as defined in the following claims. It should further be noted that any patents, applications or publications referred to herein are incorporated by reference on their entirety.

We claim:

1. A system for storing medical information and deploy applications using the Internet as shown and described in the above description.

2. A method for managing medical information, comprising:
a) collecting patient records and/or demographic data;
b) reducing said data;
c) compressing said data;
d) extracting the features of data in the form of images;
e) processing and storing said data;
f) retrieving said data; and
g) displaying and/or reporting said data.
